(19) United States
(12) Patent Application Publication
(10) Pub. No.: US 2023/0077419 A1
(43) Pub. Date: Mar. 16, 2023

(54) WATER STOPPING TAPE

(71) Applicant: FUJIFILM CORPORATION, Tokyo (JP)

(72) Inventors: Kyohisa UCHIUMI, Kanagawa (JP); Kentaro YAMURA, Kanagawa (JP)

(21) Appl. No.: 17/821,797

(22) Filed: Aug. 24, 2022

(30) Foreign Application Priority Data
Sep. 3, 2021 (JP) 2021-143891

(51) Int. Cl. C09J 7/38

(52) U.S. Cl. CPC C09J 7/38; C09J 2301/122; C09J 2301/206; C09J 2301/302; C09J 2301/312; C09J 2400/26; C09J 2400/221

(57) ABSTRACT

Provided is a water stopping tape having excellent workability.

The water stopping tape includes a substrate layer, a pressure-sensitive adhesive layer that is located on the substrate layer, and a swelling layer that is located on the substrate layer together with the pressure-sensitive adhesive layer and has at least one kind of deformation assisting structure selected from the group consisting of a groove and a cut.

### CROSS REFERENCE TO RELATED APPLICATION

This application claims priority from Japanese Patent Application No. 2021-143891, filed Sep. 3, 2021, the disclosure of which is incorporated herein by reference in its entirety.

### BACKGROUND OF THE INVENTION

### 1. Field of the Invention

The present disclosure relates to a water stopping tape.

### 2. Description of the Related Art

In order to reduce the damage caused by flooding or water leakage, various water stopping techniques are being studied. For example, JP2009-084840A discloses a study on water stopping properties for nail holes formed in a waterproof sheet for construction groundworks.

In the waterproof sheet for construction groundworks disclosed in JP2009-084840A, a nonwoven fabric having a swelling layer consisting of a water-absorbent polymer resin is interposed between two layers of synthetic resin films.

### SUMMARY OF THE INVENTION

As a water stopping technique, a method of covering a water inlet or a water outlet with a water stopping tape is being studied. For example, in many cases, the flood damage on a building is caused by the entering of water into the building through the gaps in objects such as windows and doors. Covering the gaps in objects such as windows and doors with a water stopping tape is considered as being effective for preventing or reducing the aforementioned flood damage. However, during construction using a water stopping tape, the surface of an object to be covered with the water stopping tape is not always planar. For example, the water stopping tape is required to have higher workability not only for a planar surface but also for a non-planar surface such as a curved surface.

An embodiment of the present disclosure aims to provide a water stopping tape that has excellent workability.

The present disclosure includes the following aspects.

<1> A water stopping tape including a substrate layer, a pressure-sensitive adhesive layer that is located on the substrate layer, and a swelling layer that is located on the substrate layer together with the pressure-sensitive adhesive layer and has at least one kind of deformation assisting structure selected from the group consisting of a groove and a cut.

<2> The water stopping tape described in<1>, in which in a plane view of the water stopping tape observed from the swelling layer in a direction of the substrate layer, the deformation assisting structure is in the form of a line.

<3> The water stopping tape described in<1> or <2>, in which in a plane view of the water stopping tape observed from the swelling layer in a direction of the substrate layer, the deformation assisting structure is formed along a first direction orthogonal to a thickness direction of the swelling layer.

<4> The water stopping tape described in<1> or <2>, in which in a plane view of the water stopping tape observed from the swelling layer in a direction of the substrate layer, the deformation assisting structure is formed along a first direction orthogonal to a thickness direction of the swelling layer and along a second direction that intersects with the first direction.

<5> The water stopping tape described in any one of <1> to <4>, in which the swelling layer contains a water-absorbent polymer and a nonwoven fabric.

<6> The water stopping tape described in any one of <1> to <4>, in which the swelling layer includes a mixed region where the water-absorbent polymer and the nonwoven fabric overlap each other in a cross-sectional view.

<7> A water stopping tape including a substrate layer, a pressure-sensitive adhesive layer that is located on the substrate layer, and a swelling layer that is located on the substrate layer together with the pressure-sensitive adhesive layer, in which in a case where L1 represents a load necessary for causing a displacement of 1 mm in a 3-point bending test in which a load acting toward the swelling layer from the substrate layer is applied to a first measurement point, and L2 represents a load necessary for causing a displacement of 1 mm in a 3-point bending test in which a load acting toward the swelling layer from the substrate l

ayer is applied to a second measurement point, L1 and L2 satisfy a relationship of L1 < L2.

According to an embodiment of the present disclosure, there is provided a water stopping tape having excellent workability.

### BRIEF DESCRIPTION OF THE DRAWINGS

FIG. 1 is a schematic perspective view showing a water stopping tape according to an embodiment.

FIG. 2 is a schematic cross-sectional view showing a cross section taken along the line II-II in FIG. 1.

FIG. 3 is a schematic cross-sectional view showing a water stopping tape according to another embodiment.

FIG. 4 is a schematic cross-sectional view showing a water stopping tape according to still another embodiment.

FIG. 5 is a schematic perspective view showing a water stopping tape according to yet another embodiment.

FIG. 6 is a schematic perspective view showing a water stopping tape according to another embodiment.

### DESCRIPTION OF THE PREFERRED EMBODIMENTS

Hereinafter, embodiments of the present disclosure will be specifically described. The present disclosure is not limited to the following embodiments. The following embodiments may be modified as appropriate within the intended scope of the present disclosure.

In a case where the embodiments of the present disclosure are described with reference to the drawings, sometimes the constituents and reference numerals overlapping in the drawings are not described. The constituents represented by the same reference numeral in the drawings are the same constituents. The dimensional ratio in the drawings does not necessarily represent the actual dimensional ratio. For convenience, sometimes a certain constituent is highlighted in the drawings.

In the present disclosure, a range of numerical values described using “to” means a range including the numerical values listed before and after “to” as the lower limit and the upper limit.

As for numerical ranges described stepwise in the present disclosure, the upper limit of a certain numerical range may be replaced with the upper limit of another numerical range described stepwise, and the lower limit of a certain numerical range may be replaced with the lower limit of another numerical range described stepwise. In addition, as for the numerical ranges described stepwise in the present disclosure, the upper or lower limit of a certain numerical range may be replaced with the values described in examples.

In the present disclosure, in a case where there is a plurality of substances in a composition that corresponds to each component of the composition, unless otherwise specified, the amount of each component in the composition means the total amount of the plurality of substances present in the composition.

In the present disclosure, a combination of preferable aspects is a more preferable aspect.

In the present disclosure, the ordinal numerals (for example, “the first” and “the second”) are terms used to distinguish the elements and do not limit the number of elements and the superiority or inferiority of the elements.

### Water Stopping Tape

Hereinafter, a water stopping tape according to an aspect of the present disclosure will be described. Specifically, hereinafter, a water stopping tape according to a first embodiment and a water stopping tape according to a second embodiment will be described in this order.

### Water Stopping Tape According to the First Embodiment

The water stopping tape according to the first embodiment includes a substrate layer, a pressure-sensitive adhesive layer, and a swelling layer. The pressure-sensitive adhesive layer is located on the substrate layer. The swelling layer is located on the substrate layer together with the pressure-sensitive adhesive layer. The swelling layer has at least one kind of deformation assisting structure (hereinafter, called “specific structure” in some cases) selected from the group consisting of a groove and a cut. According to the above embodiment, there is provided a water stopping tape having excellent workability. Presumably, because the specific structure of the swelling layer easily induces bending deformation of the water stopping tape, excellent workability may be obtained. That is, the specific structure of the swelling layer can form a starting point of bending deformation of the water stopping tape. In a case where the bending deformation of the water stopping tape can easily occur, the water stopping tape is easily deformed along a non-planar surface such as a curved surface. As a result, during the construction using the water stopping tape, for example, the water stopping tape is easily deformed along the shape of an object, and the workability is improved.

### Substrate Layer

### The Water Stopping Tape According to the First Wmbodiment Includes a Substrate Layer

Examples of the components of the substrate layer include a resin and a metal. The substrate layer is preferably a substrate layer containing a resin, that is, a resin substrate layer. Examples of the resin include polyolefin, polyester, polyethylene terephthalate (PET), polyethylene naphthalate (PEN), an acrylic resin, polycarbonate (PC), triacetyl cellulose (TAC), a cycloolefin polymer (COP), and an acrylonitrile/butadiene/styrene copolymer resin (ABS resin). From the viewpoint of waterproofness, the substrate layer preferably contains polyethylene, polypropylene, or polyester. The substrate layer may contain one kind of resin or two or more kinds of resins.

It is preferable that the substrate layer have a waterproof function. In a case where the substrate layer has a waterproof function, the water stopping tape held in a predetermined place improves durability against water. In the present disclosure, “waterproof function” means that the leakage amount of water leaking through the substrate layer per hour is 500 g or less in a leak test by filling water at a diameter of 10 mm. The water leakage amount is measured by the following method. First, the substrate layer is collected from the water stopping tape. A cylindrical tube with a diameter of 10 mm is filled with water to a depth of 100 mm. The substrate layer is attached to the opening of the cylindrical tube, and a lid is put thereon. The cylindrical tube is turned upside down and kept as it is for 1 hour. The amount of water leaking for 1 hour (unit: g) is measured.

The thickness of the substrate layer is, for example, 15 µm to 200 µm. In the present disclosure, “thickness of the substrate layer” is represented by the arithmetic mean of the thicknesses of the substrate layer measured at five sites.

The length and width of the substrate layer are not limited. The substrate layer is preferably an elongated layer. For the elongated substrate layer, “length of the substrate layer” means the length of the substrate layer in the longitudinal direction, “width of the substrate layer” means the length of the substrate layer in a direction that is orthogonal to the longitudinal direction and thickness direction of the substrate layer.

### Pressure-Sensitive Adhesive Layer

The water stopping tape according to the first embodiment includes a pressure-sensitive adhesive layer located on the substrate layer. The pressure-sensitive adhesive layer is a layer that functions as a pressure-sensitive adhesive. In the present disclosure, “pressure-sensitive” means that the layer can be stuck to a member (for example, glass) and can be peeled off from the member (for example, glass).

The pressure-sensitive adhesive layer preferably contains a pressure-sensitive adhesive component. Examples of the pressure-sensitive adhesive component include a silicone resin, an acrylic resin, a vinyl resin, a polyurethane, a polyamide, a polyester, a polyolefin, and rubber.

Examples of the silicone resin include an addition reaction-type silicone resin, a peroxide curing-type silicone resin, and a condensation-type silicone resin.

Examples of the acrylic resin include a homopolymer of an acrylic acid ester compound and a copolymer of an acrylic acid ester compound and other monomers. Examples of the acrylic acid ester compound include methyl (meth)acrylate, ethyl (meth)acrylate, butyl (meth)acrylate, 2-ethylhexyl (meth)acrylate, hydroxyethyl methacrylate, hydroxypropyl methacrylate, dimethylaminoethyl methacrylate, and glycidyl methacrylate. Examples of the aforementioned other monomers include vinyl acetate, (meth)acrylonitrile, (meth)acrylamide, styrene, a methacrylic acid, an acrylic acid, itaconic acid, methylolacrylamide, and maleic acid anhydride.

Examples of the vinyl resin include polyvinyl alcohol and polyvinylpyrrolidone.

Examples of the polyurethane include polyester polyurethane and polycarbonate polyurethane.

Examples of the polyamide include a polyamide obtained by ring-opening polycondensation of undecane lactam (amide 11) and a polyamide obtained by ring-opening polycondensation of lauryl lactam (amide 12).

Examples of the polyester include a polycondensate of a polyvalent carboxylic acid and a polyhydric alcohol. Specifically, examples thereof include polyethylene terephthalate and polybutylene terephthalate.

Examples of the polyolefin include a homopolymer of an olefin and a copolymer of an olefin and other monomers. The olefin is preferably an olefin having 2 to 6 carbon atoms. Examples of the olefin include ethylene, propylene, butene, methylpentene, and hexene. Examples of the copolymer of an olefin and other monomers include an ethylene-vinyl acetate copolymer resin (EVA), an ethylene-acrylic acid copolymer (EAA), an ethylene-ethyl acrylate copolymer (EEA), and an ethylene-methyl methacrylate copolymer (EMMA).

Examples of the rubber include a styrene/butadiene copolymer (SBR, SBS), a styrene/isoprene copolymer (SIS), an acrylonitrile-butadiene copolymer (NBR), a chloroprene polymer, and an isobutylene/isoprene copolymer (butyl rubber).

The pressure-sensitive adhesive layer may contain one kind of pressure-sensitive adhesive component or two or more kinds of pressure-sensitive adhesive components.

The thickness of the pressure-sensitive adhesive layer is, for example, 10 µm to 500 µm. In the present disclosure, “thickness of the pressure-sensitive adhesive layer” is represented by the arithmetic mean of the thicknesses of the pressure-sensitive adhesive layer measured at five sites.

The pressure-sensitive adhesive layer is formed, for example, by applying a composition for a pressure-sensitive adhesive layer containing a pressure-sensitive adhesive component on the substrate layer and drying the composition. The composition for a pressure-sensitive adhesive layer may contain other components. Examples of those other components include a solvent, an ultraviolet absorber, an antioxidant, a crosslinking agent, a surfactant, a filler, a colorant, a light stabilizer, a thickener, and a polymerization initiator.

The pressure-sensitive adhesive layer may be a pressure-sensitive adhesive material obtained by peeling off a peelable liner of a double-sided pressure-sensitive adhesive sheet or a double-sided pressure-sensitive adhesive tape. By attaching the pressure-sensitive adhesive material, which is obtained by peeling off a peelable liner of a double-sided pressure-sensitive adhesive sheet or a double-sided pressure-sensitive adhesive tape, onto the substrate layer, it is possible to form the pressure-sensitive adhesive layer. The double-sided pressure-sensitive adhesive sheet and the double-sided pressure-sensitive adhesive tape may be commercially available products.

The laminate including the substrate layer and the pressure-sensitive adhesive layer may be a commercially available single-sided pressure-sensitive adhesive sheet or single-sided pressure-sensitive adhesive tape.

### Swelling Layer

The water stopping tape according to the first embodiment includes a swelling layer that is located on the substrate layer together with the pressure-sensitive adhesive layer. The swelling layer is a layer having a function of absorbing water and expanding.

The positional relationship between the swelling layer and the pressure-sensitive adhesive layer is not limited unless the gist of the present disclosure is significantly impaired. The swelling layer may be located next to the pressure-sensitive adhesive layer on the substrate layer. The swelling layer may be located on the substrate layer and the pressure-sensitive adhesive layer. In other words, the water stopping tape may include a substrate layer, a pressure-sensitive adhesive layer, and a swelling layer in this order. The swelling layer may be the outermost layer.

The swelling layer has at least one kind of deformation assisting structure (that is, the specific structure) selected from the group consisting of a groove and a cut. As described above, the specific structure of the swelling layer can form the starting point of bending deformation of the water stopping tape, and improve the workability of the water stopping tape. For example, in a case where the water stopping tape is easily deformed along the shape of an object during the work of applying the water stopping tape, gaps are unlikely to occur between the object and the water stopping tape after the work of applying the water stopping tape. Furthermore, from the viewpoint of water stopping properties, the specific structure of the swelling layer is expected to increase the contact area of the swelling layer with water and facilitate the permeation of water into the swelling layer. The swelling layer may have a groove or cut. The swelling layer may have both the groove and cut. In a case where the swelling layer has both the groove and cut, at least a part of the groove may be connected to at least a part of the cut. In a case where the swelling layer has both the groove and cut, the groove and cut may be in the form of groove and cut independent of each other. From the viewpoint of workability and water stopping properties, it is preferable that the swelling layer have a groove.

In a plane view of the water stopping tape observed from the swelling layer in the direction of the substrate layer (hereinafter, simply described as “in a plane view” in some cases), the specific structure is preferably in the form of a line. From another point of view, in a case where a surface of the swelling layer facing the substrate layer is assumed to be “the first surface” and a surface of the swelling layer opposite to the first surface is assumed to be “the second surface”, the specific structure is preferably in the form of a line on the second surface of the swelling layer. In a case where the specific structure is in the form of a line in a plane view, bending deformation of the water stopping tape easily occurs, which improves the workability. For example, in a case where the specific structure is in the form of a line in a plane view, the water stopping tape is likely to bend in the form of a projection protruding toward the swelling layer from the substrate layer. The term “line” includes a straight line and a curve. The specific structure may be in the form of a combination of a straight line and a curve. It is preferable that the specific structure be in the form of a straight line in a plane view. A plurality of specific structures may be formed in a plane view.

From the viewpoint of workability, in a plane view of the water stopping tape observed from the swelling layer in the direction of the substrate layer, it is preferable that the specific structure be formed along a first direction orthogonal to the thickness direction of the swelling layer. The first direction is preferably the length direction of the swelling layer. The first direction is more preferably the longitudinal direction of the swelling layer.

From the viewpoint of workability, in a plane view of the water stopping tape observed from the swelling layer in the direction of the substrate layer, it is preferable that the specific structure be formed along a first direction orthogonal to the thickness direction of the swelling layer and along a second direction that intersects with the first direction. The angle between the first direction and the second direction is preferably 80° to 110°, more preferably 85° to 105°, and even more preferably 88° to 102°. The angle between the first direction and the second direction may be 90°. That is, the second direction may intersect with the first direction at a right angle. In a plane view, the specific structure may be in the form of a lattice. The first direction is preferably the length direction of the swelling layer, and the second direction is preferably the width direction of the swelling layer. The first direction is more preferably the longitudinal direction of the swelling layer, and the second direction is more preferably the lateral direction of the swelling layer.

The groove may pass completely through the swelling layer. The groove may not pass completely through the swelling layer. From the viewpoint of workability and water stopping properties, it is preferable that the groove do not pass completely through the swelling layer.

Examples of the shape of the groove in a cross-sectional view of the swelling layer include a polygon and a semicircle. Examples of the polygon include a triangle and a quadrangle. Examples of the quadrangle include a square, a rectangle, and a trapezoid. Among these, a quadrangle is preferable.

From the viewpoint of workability, the width of the groove is preferably 0.1 mm or more, more preferably 0.5 mm or more, and even more preferably 1 mm or more. Furthermore, the width of the groove is preferably 1.5 mm or more, and more preferably 2 mm or more. From the viewpoint of water stopping properties, the width of the groove is preferably 8 mm or less, more preferably 5 mm or less, and even more preferably 3 mm or less. In the present disclosure, “width of the groove”is represented by the arithmetic mean of the widths of five grooves selected in a cross-sectional image of the swelling layer. As necessary, two or more cross-sectional images may be used. In a case where the width of the target groove changes continuously or discontinuously in the cross-sectional image of the swelling layer, the maximum width of the target groove is adopted.

From the viewpoint of workability, the depth of the groove is preferably 0.1 mm or more, more preferably 0.2 mm or more, and even more preferably 0.3 mm or more. Furthermore, the depth of the groove is preferably 0.4 mm or more, and more preferably 0.5 mm or more. From the viewpoint of water stopping properties, the depth of the groove is preferably 5 mm or less, more preferably 4 mm or less, and even more preferably 3 mm or less. Furthermore, the depth of the groove is preferably 2 mm or less, and more preferably 1 mm or less. In the present disclosure, “depth of the groove”is represented by the arithmetic mean of the depths of five grooves selected in a cross-sectional image of the swelling layer. As necessary, two or more cross-sectional images may be used.

From the viewpoint of workability, the ratio of the depth of the groove to the width of the groove (that is, [depth of groove]/[width of groove]) is preferably 0.05 or more, more preferably 0.1 or more, and even more preferably 0.2 or more. From the viewpoint of water stopping properties, [depth of groove]/[width of groove] is preferably 1 or less, more preferably 0.5 or less, and even more preferably 0.3 or less.

From the viewpoint of workability, the ratio of the depth of the groove to the thickness of the swelling layer (that is, [depth of groove]/[thickness of swelling layer]) is preferably 0.05 or more, more preferably 0.1 or more, and even more preferably 0.2 or more. From the viewpoint of water stopping properties, [depth of groove]/[thickness of swelling layer] is preferably 1 or less, more preferably 0.5 or less, and even more preferably 0.3 or less.

The cut may pass completely through the swelling layer. The cut may not pass completely through the swelling layer. From the viewpoint of workability and water stopping properties, it is preferable that the cut do not pass completely through the swelling layer.

The preferable aspect of the depth of the cut is the same as the preferable aspect of the depth of the groove. In the present disclosure, “depth of the cut”is represented by the arithmetic mean of the depths of five cuts selected in a cross-sectional image of the swelling layer. As necessary, two or more cross-sectional images may be used.

The preferable aspect of the ratio of the depth of the cut to the thickness of the swelling layer (that is, [depth of cut]/[thickness of swelling layer]) is the same as the preferable aspect of the ratio of the depth of the groove to the thickness of the swelling layer (that is, [depth of groove]/[thickness of swelling layer]).

In a case where L1 represents a load necessary for causing a displacement of 1 mm in a 3-point bending test of applying a load acting toward the specific structure of the swelling layer from the substrate layer, from the viewpoint of workability, the load L1 is preferably 10 g or less, more preferably 8 g or less, and even more preferably 6 g or less. Furthermore, the load L1 is preferably 4 g or less, more preferably 2 g or less, and even more preferably 1 g or less. From the viewpoint of durability, the load L1 is preferably 0.1 g or more, and more preferably 0.5 g or more. In a case where there is a plurality of candidates as the load L1 in the 3-point bending test, the minimum load is adopted. In the 3-point bending test, the distance between supporting points is set to 10 mm. The tip of an indenter used in the 3-point bending test is in the form of a 45° cone. The matters relating to the above 3-point bending test are also applied to the 3-point bending test for measuring a load L2 that will be described later.

In a case where L1 represents a load necessary for causing a displacement of 1 mm in a 3-point bending test of applying a load acting toward the specific structure of the swelling layer from the substrate layer, and L2 represents a load necessary for causing a displacement of 1 mm in a 3-point bending test of applying a load acting toward a region of the swelling layer excluding the specific structure from the substrate layer, from the viewpoint of workability, L1 and L2 preferably satisfy a relationship of L1 < L2. “Region of the swelling layer excluding the specific structure” means a region of the swelling layer where none of the groove and cut are formed. The smaller the load L1 compared to the load L2, the easier it is for bending deformation to occur in the water stopping tape, which improves workability. From the viewpoint of workability, the ratio of the load L1 to the load L2 (that is, L1/L2) is preferably 90% or less, more preferably 80% or less, and even more preferably 70% or less. Furthermore, L1/L2 is preferably 60% or less, more preferably 50% or less, and even more preferably 40% or less. In addition, L1/L2 is preferably 30% or less, more preferably 20% or less, and even more preferably 10% or less. From the viewpoint of durability, L1/L2 is preferably 1% or more, more preferably 5% or more, and even more preferably 8% or more.

From the viewpoint of water stopping properties, it is preferable that the swelling layer contain a water-absorbent polymer.

The water absorption rate of the water-absorbent polymer is preferably 12% or more, more preferably 15% or more, and even more preferably 20% or more. From the viewpoint of durability, the water absorption rate of the water-absorbent polymer is preferably 60% or less, and more preferably 50% or less. In the present disclosure, “water absorption rate” is expressed by the mass percentage of the amount of water absorbed that is measured based on the method A described in “JIS K 7209: 2000”.

Examples of the water-absorbent polymer include a polyurethane, a (meth)acrylic polymer, a vinyl-based polymer, and polysaccharides. Examples of the water-absorbent polymer also include hydrophilic polyester, gelatin, a starch/sodium acrylate graft copolymer, and an isobutylene/maleic acid anhydride copolymer.

From the viewpoint of water stopping properties, the water-absorbent polymer preferably includes at least one kind of polymer selected from the group consisting of a polyurethane, a (meth)acrylic polymer, a vinyl-based polymer, and polysaccharides, more preferably includes at least one kind of polymer selected from the group consisting of a polyurethane and a (meth)acrylic polymer, and even more preferably includes a polyurethane.

It is preferable that the swelling layer contain a polyurethane as a water-absorbent polymer. The structure of the polyurethane can be designed with a high degree of freedom, and the water absorbency can be freely adjusted depending on the structure design. In addition, the water stopping tape containing a polyurethane as the water-absorbent polymer can exhibit high water stopping properties even to water having a high salt concentration such as sea water. Because most polyurethanes are soluble in a solvent and have thermoplasticity, the environmental load in the manufacturing process could be reduced.

From the viewpoint of improving water stopping properties and a degree of freedom of structure design, the polyurethane preferably includes a hard segment and a soft segment. The hard segment is a region that is relatively harder than the soft segment. The hard segment is formed, for example, by the reaction between a short-chain polyol (for example, a low-molecular-weight diol) and an isocyanate. Because the soft segment can carry water, increasing the proportion of the soft segment leads to the increase of water absorbency. The soft segment is formed, for example, by the reaction between a long-chain polyol (for example, a polyalkylene oxide) and an isocyanate.

The polyurethane may be selected from known polyurethanes having water absorptivity. Examples of the polyurethane include a polyurethane obtained by reacting an active hydrogen-containing compound with an isocyanate. Examples of preferable polyurethanes include a polyurethane obtained by reacting a polyalkylene oxide, a diol having a molecular weight of 500 or less, and a diisocyanate. The polyalkylene oxide and the diisocyanate contribute to the formation of the soft segment. The diol having a molecular weight of 500 or less and the diisocyanate contribute to the formation of the hard segment.

Examples of the active hydrogen-containing compound include a compound having a hydroxy group. Examples of the compound having a hydroxy group include a polyalkylene oxide and a low-molecular-weight diol. One kind of active hydrogen-containing compound or two or more kinds of active hydrogen-containing compounds may be used.

Examples of the polyalkylene oxide include polyethylene oxide and polypropylene oxide. The polyalkylene oxide preferably includes polyethylene oxide. The polyalkylene oxide is preferably at least one kind of compound selected from the group consisting of polyethylene oxide and polypropylene oxide, and more preferably polyethylene oxide. One kind of polyalkylene oxide or two or more kinds of polyalkylene oxides may be used. The polyalkylene oxide may be polyethylene oxide or polypropylene oxide.

In a case where polyethylene oxide and polypropylene oxide are used together, the ratio of the total mass of the polypropylene oxide to the total mass of the polyethylene oxide (that is, [total mass of polypropylene oxide]/[total mass of polyethylene oxide]) is preferably 0.10 to 0.35, more preferably 0.15 to 0.30, and even more preferably 0.15 to 0.25.

The weight-average molecular weight of the polyalkylene oxide is preferably 3,000 to 100,000, more preferably 3,000 to 80,000, and even more preferably 3,000 to 60,000.

The weight-average molecular weight of the polyethylene oxide is preferably 10,000 to 100,000, more preferably 20,000 to 80,000, and even more preferably 30,000 to 60,000.

The weight-average molecular weight of the polypropylene oxide is preferably 3,000 to 50,000, more preferably 3,000 to 30,000, and even more preferably 3,000 to 10,000.

In the present disclosure, the weight-average molecular weight is measured by gel permeation chromatography (GPC). The measurement conditions of gel permeation chromatography (GPC) are as follows. The calibration curve is plotted from 8 samples of "Standard sample TSK standard, polystyrene" manufactured by Tosoh Corporation: "F-40", "F-20", "F-4", "F-1", "A-5000", "A-2500", "A-1000", and "n-propylbenzene".

Measuring device: HLC (registered trademark)-8020GPC (manufactured by Tosoh Corporation)
Column: TSKgel (registered trademark) Super Multipore HZ-H (4.6 mm ID × 15 cm, manufactured by Tosoh Corporation) × 3
Eluent: tetrahydrofuran (THF), N-methylpyrrolidone (NMP), dimethylformamide (DMF), or water
Sample concentration: 0.45% by mass
Flow rate: 0.35 mL/min
Amount of sample injected: 10 µL
Measurement temperature: 40° C.
Detector: RI detector

Examples of the low-molecular-weight diol include a diol having a molecular weight of 500 or less. The lower limit of the molecular weight of the diol may be 62. Examples of the low-molecular-weight diol include ethylene glycol, diethylene glycol, triethylene glycol, tetraethylene glycol, propylene glycol, dipropylene glycol, trimethylene glycol, 1,3-butanediol, 2,3-butanediol, 1,4-butanediol, 1,5-pentanediol, hexylene glycol, octylene glycol, glyceryl monoacetate, glyceryl monobutyrate, 1,6-hexanediol, and 1,9-nonanediol. The low-molecular-weight diol is preferably 1,4-butanediol. One kind of low-molecular-weight diol or two or more kinds of low-molecular-weight diols may be used.

Examples of the isocyanate include a diisocyanate. Examples of the diisocyanate include an aliphatic diisocyanate and an aromatic diisocyanate. Specific examples of the diisocyanate include 4,4'-diphenylmethane diisocyanate, 1,6-hexamethylene diisocyanate, 1,8-dimethylbenzol-2,4-diisocyanate, 2,4-tolylene diisocyanate, 2,2'-dimethyl-4,4'-diphenylmethane diisocyanate, 1,3-bis(isocyanatemethyl)benzene, 1,4-bis(isocyanatemethyl)benzene, 1,3-bis(isocyanatemethyl)cyclohexane, 1,4-bis(isocyanatemethyl)cyclohexane, 4,4'-dicyclohexylmethane diisocyanate, and isophorone diisocyanate. The diisocyanate is preferably 4,4'-diphenylmethane diisocyanate. One kind of isocyanate or two or more kinds of isocyanates may be used.

The polyurethane may be a commercially available product. Examples of the commercially available product include a super water-absorbent thermoplastic polyurethane elastomer manufactured by BASF SE (trade name: ELASTOLLAN BO38) and a hydrophilic polyurethane (trade names: AQUACALK C, AQUACALK TWB, and AQUACALK TWB-P) manufactured by SUMITOMO SEIKA CHEMICALS CO.,LTD.

It is preferable that the swelling layer contain a (meth)acrylic polymer as a water-absorbent polymer. “(Meth)acrylic polymer” means a polymer containing a constitutional unit derived from a monomer having a (meth)acryloyl group. The term “(meth)acryloyl group” includes an acryloyl group or a methacryloyl group or includes both the acryloyl group and methacryloyl group.

The (meth)acrylic polymer may be a homopolymer or a copolymer.

Examples of the monomer having a (meth)acryloyl group include a (meth)acrylic acid, a (meth)acrylamide, and a (meth)acrylic acid ester.

Examples of the (meth)acrylamide include acrylamide, methacrylamide, N-methylacrylamide, N,N′-dimethylacrylamide, N,N′-dimethylmethacrylamide, and N-methylolacrylamide.

The (meth)acrylic acid ester is preferably a (meth)acrylic acid alkyl ester, and more preferably a (meth)acrylic acid alkyl ester having 1 to 4 carbon atoms in the alkyl moiety. Examples of the (meth)acrylic acid alkyl ester include methyl (meth)acrylate, ethyl (meth)acrylate, butyl (meth)acrylate, and isobutyl (meth)acrylate.

Examples of the (meth)acrylic polymer include a polyacrylic acid, a polymethacrylic acid, a polyacrylate (for example, sodium polyacrylate), a crosslinked polyacrylic acid, a crosslinked polyacrylate, an acrylic acid/acrylate copolymer, a polyacrylamide, polymethacrylamide, an acrylamide/acrylic acid copolymer, an acrylamide/methacrylic acid copolymer, an acrylamide/methyl acrylate copolymer, an acrylamide/methyl methacrylate copolymer, a N,N′-dimethylacrylamide/N-methylolacrylamide/methyl methacrylate copolymer, polymethyl (meth)acrylate, polyethyl (meth)acrylate, polybutyl (meth)acrylate, and polyisobutyl (meth)acrylate.

The weight-average molecular weight of the (meth)acrylic polymer is preferably 100,000 to 10,000,000, more preferably 250,000 to 5,000,000, and even more preferably 500,000 to 2,500,000. The weight-average molecular weight is measured by the method described above.

It is preferable that the swelling layer contain a vinyl-based polymer as a water-absorbent polymer. “Vinyl-based polymer” means a polymer containing a constitutional unit derived from a monomer having a vinyl group. The vinyl-based polymer may be a homopolymer or a copolymer.

Examples of the monomer having a vinyl group include vinyl acetate, vinylpyrrolidone, and vinyl methyl ether.

Examples of the vinyl-based polymer include polyvinyl alcohol, polyvinylpyrrolidone, polyvinylpolypyrrolidone, and polyvinyl methyl ether.

It is preferable that the swelling layer contain polysaccharides as a water-absorbent polymer. Examples of the polysaccharides include alginate, xanthan gum, gellan gum, gum tragacanth, karaya gum, gum arabic, carrageenan, dextrin, agar, pectin, pullulan, locust bean gum, sacran, tamarind seed gum, hydroxyethyl cellulose, hydroxypropyl cellulose, carboxymethyl cellulose, carboxymethyl ethyl cellulose, a hydroxypropyl cellulose salt, a carboxymethyl cellulose salt, a carboxymethyl ethyl cellulose salt, cellulose nanofibers (for example, Tempo-oxidized cellulose nanofibers, carboxymethylated cellulose nanofibers, phosphoesterified cellulose nanofibers, and mechanically defibrated cellulose nanofibers), chitosan nanofibers, cellulose microfibrils, hyaluronate, and hyaluronic acid.

It is preferable that the water-absorbent polymer be crosslinked. The water-absorbent polymer crosslinked in advance may be used, or the water-absorbent polymer may be crosslinked in the process of forming the swelling layer.

In the swelling layer, the water-absorbent polymer may form a layer. For example, the swelling layer may include a water-absorbent polymer-containing layer. The water-absorbent polymer-containing layer may further contain components other than the water-absorbent polymer. The water-absorbent polymer-containing layer may further contain other components that will be described later.

The swelling layer may contain one kind of water-absorbent polymer or two or more kinds of water-absorbent polymers.

From the viewpoint of water stopping properties, the ratio of the total mass of the water-absorbent polymer to the total mass of the swelling layer is preferably 10% by mass to 100% by mass, more preferably 30% by mass to 100% by mass, and even more preferably 50% by mass to 100% by mass. The ratio of the total mass of the water-absorbent polymer to the total mass of the swelling layer may be less than 100% by mass.

It is preferable that the swelling layer contain a fiber assembly. The fiber assembly can improve the durability of the swelling layer.

Examples of the fiber assembly include a nonwoven fabric, a fabric, and a knit. The fiber assembly is preferably a nonwoven fabric, a fabric, or a knit, and more preferably a nonwoven fabric. For example, the nonwoven fabric is expected to bring about an effect of maintaining strength of the swelling layer that is swollen. Furthermore, for example, the nonwoven fabric is expected to bring about an effect of suppressing leakage of the water-absorbent polymer (including the water-absorbent polymer having absorbed water) from the swelling layer that is swollen.

Examples of the fibers contained in the fiber assembly include cellulose fibers, rayon fibers, polyolefin fibers (for example, polyethylene fibers and polypropylene fibers), polyvinyl chloride fibers, polyester fibers, polyurethane fibers, and polyamide fibers. The fiber assembly preferably contains at least one kind of fibers selected from the group consisting of cellulose fibers, rayon fibers, polyolefin fibers, and polyester fibers, and more preferably contains at least one kind of fibers selected from the group consisting of rayon fibers, polyolefin fibers, and polyester fibers. The fiber assembly may contain rayon fibers, polyolefin fibers, and polyester fibers.

The fiber assembly may be a commercially available product. Examples of commercially available products thereof include TECHNOWIPE RN100-M (NIPPON PAPER CRECIA CO., LTD.).

It is preferable that the swelling layer contain a water-absorbent polymer and a fiber assembly. The water-absorbent polymer may be between the fibers of the fiber assembly. The water-absorbent polymer may be in contact with the fibers of the fiber assembly. The water-absorbent polymer may cover the fibers of the fiber assembly. The water-absorbent polymer may permeate the fibers of the fiber assembly. It is preferable that the swelling layer include a mixed region where the water-absorbent polymer and the fiber assembly overlap each other in a cross-sectional view. Such a mixed region can improve the durability of the swelling layer. As a result, for example, water stopping properties last for a long time. The swelling layer may include a water-absorbent polymer-containing layer and a fiber assembly. The swelling layer may include a mixed region where the water-absorbent polymer-containing layer and the fiber assembly overlap each other in a cross-sectional view.

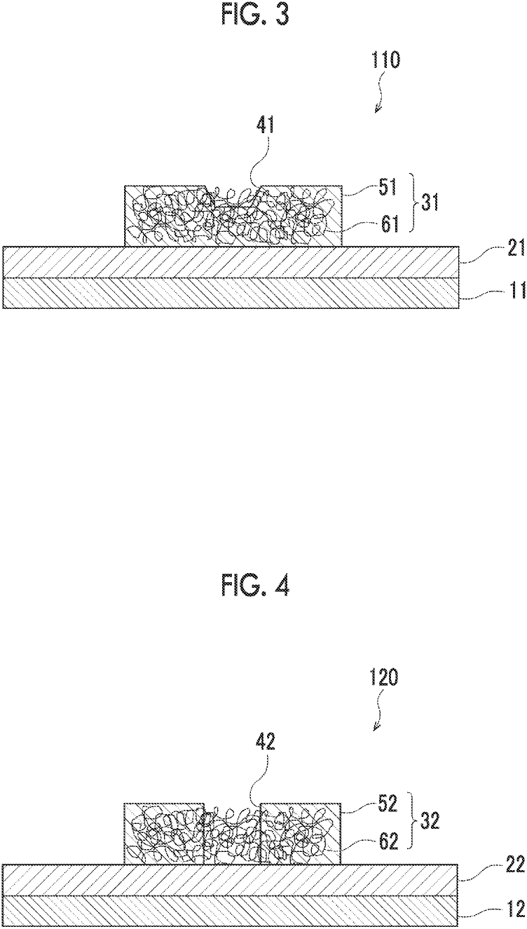

In a case where the swelling layer includes a plurality of constituents, the specific structure may be defined by at least one of the plurality of constituents included in the swelling layer. In a case where the specific structure is defined by at least one of the plurality of constituents included in the swelling layer, other constituents included in the swelling layer may be present in the specific structure. For example, as will be described later with reference to FIGS. 3 and 4, in a swelling layer containing a water-soluble polymer and a fiber assembly, a groove may be defined by the water-soluble polymer constituting the swelling layer, and a part of the fiber assembly protruding from the water-soluble polymer may be in the groove. That is, unless the gist of the present disclosure significantly impaired, it is permissible for an object to be present in a groove or cut.

The swelling layer may further contain other components. Examples of those other components include a polymer other than the water-absorbent polymer, a plasticizer, and a pressure-sensitive adhesive component. Examples of those other components also include a component derived from a composition containing the water-absorbent polymer that will be described later.

It is preferable that the swelling layer contain a plasticizer. The plasticizer can improve the workability of the water stopping tape.

Examples of the plasticizer include a polyester-based plasticizer, a polyether ester-based plasticizer, a polyvalent carboxylic acid ester-based plasticizer, a glycerin-based plasticizer, a phosphoric acid ester-based plasticizer, an epoxy-based plasticizer, and a polyacrylic acid ester-based plasticizer.

Examples of the polyester-based plasticizer include a polyester obtained by reacting an acid component (for example, adipic acid, sebacic acid, terephthalic acid, isophthalic acid, naphthalenedicarboxylic acid, or diphenyldicarboxylic acid) with a diol component (for example, propylene glycol and 1,3-butanediol, 1,4-butanediol, 1,6-hexanediol, ethylene glycol, or diethylene glycol). Examples of the polyester-based plasticizer include a polyester consisting of a hydroxycarboxylic acid (for example, polycaprolactone). The terminal of the polyester may be sealed with a monofunctional carboxylic acid or a monofunctional alcohol. The terminal of the polyester may be sealed with an epoxy compound. Examples of commercially available products thereof include ADEKACIZER PN-150, PN-170, P-200, and PN-350 manufactured by ADEKA CORPORATION.

The polyether ester-based plasticizer is preferably an organic acid ester of polyalkylene glycol. Examples of the polyalkylene glycol include polyethylene glycol, polypropylene glycol, polybutylene glycol, a poly(ethylene oxide·propylene oxide) block copolymer, a poly(ethylene oxide·propylene oxide) random copolymer, and polytetramethylene glycol. Aromatic units such as bisphenols may be contained in the polyether chain. Examples of the organic acid include a monocarboxylic acid (for example, butanoic acid, isobutanoic acid, 2-ethylbutyric acid, 2-ethylhexanoic acid, and decanoic acid). Examples of commercially available products thereof include ADEKACIZER RS-1000, RS-735, and RS-700 manufactured by ADEKA CORPORATION.

Examples of the polyvalent carboxylic acid ester-based plasticizer include an aliphatic dicarboxylic acid ester, an aromatic dicarboxylic acid ester, a trimellitic acid ester, and a citric acid ester (for example, acetyl triethyl citrate and acetyl tributyl citrate).

Examples of the aliphatic dicarboxylic acid ester include an adipic acid ester (for example, diisodecyl adipate, di-n-octyl-adipate, and di-n-decyl adipate), an azelaic acid ester (for example, di-2-ethylhexyl azelate), and a sebacic acid ester (for example, dibutyl sebacate and di-2-ethylhexyl sebacate).

Examples of the aromatic dicarboxylic acid ester include a phthalic acid ester (for example, dimethyl phthalate, diethyl phthalate, dibutyl phthalate, dioctyl phthalate, diheptyl phthalate, dibenzyl phthalate, and butyl phthalate).

Examples of the trimellitic acid ester include trimethyl trimellitate, triethyl trimellitate, tripropyl trimellitate, tributyl trimellitate, triamyl trimellitate, trihexyl trimellitate, triheptyl trimellitate, tri-n-octyl trimellitate, tri-2-ethylhexyl trimellitate, trinonyl trimellitate, triisononyl trimellitate, tris(decyl) trimellitate, tris(dodecyl) trimellitate, tris(tetradecyl) trimellitate, tris-(C8 to C12 mixed alkyl) trimellitate, tris-(C7 to C9 mixed alkyl) trimellitate, and trilauryl trimellitate. Examples of commercially available products thereof include ADEKACIZER C-8, C-880, C-79, C810, C-9N, and C-10 from ADEKA CORPORATION.

The polyvalent carboxylic acid ester-based plasticizer preferably contains an ether bond. Here, from the viewpoint of flexibility and heat resistance, a polyvalent carboxylic acid ester-based plasticizer that does not contain a polyalkylene oxide structure is preferable. Examples of commercially available products thereof ADEKACIZER RS-107 (dibutoxyethoxyethyl adipate) manufactured by ADEKA CORPORATION. The above compounds are called adipic acid ether ester-based compound.

Examples of the glycerin-based plasticizer include glycerin monoaceto monolaurate, glycerin diaceto monolaurate, glycerin monoaceto monostearate, glycerin diaceto monooleate, and glycerin monoaceto monomontanate.

Examples of the phosphoric acid ester-based plasticizer include tributyl phosphate, tri-2-ethylhexyl phosphate, trioctyl phosphate, triphenyl phosphate, diphenyl-2-ethylhexyl phosphate, and tricresyl phosphate.

Examples of the epoxy-based plasticizer include epoxy triglyceride consisting of an alkyl epoxy stearate and soybean oil. Examples of the epoxy-based plasticizer also include an epoxy resin that contains bisphenol A and epichlorohydrin as raw materials.

Examples of the polyacrylic acid ester-based plasticizer include a polymer of an acrylic acid alkyl ester. The polyacrylic acid ester-based plasticizer may have functional groups such as an epoxy group and a carboxy group. Examples of commercially available products thereof include ARUFON series manufactured by TOAGOSEI CO., LTD. (for example, non-functional UP series).

Examples of other plasticizers include benzoic acid esters of aliphatic polyols such as neopentyl glycol dibenzoate, diethylene glycol dibenzoate, and triethylene glycol di-2-ethylbutyrate, fatty acid amides such as stearic acid amide, aliphatic carboxylic acid esters such as butyl oleate, oxyacid esters such as methyl acetyl ricinolate and butyl acetyl ricinolate, pentaerythritol, sorbitol, a polyacrylic acid ester, silicone oil, and paraffins.

From the viewpoint of heat resistance and effect of the plasticizer, the molecular weight of the plasticizer is preferably 400 to 10,000, and more preferably 500 to 2,000. In a case where the plasticizer has a molecular weight distribution, it is preferable that the weight-average molecular weight of the plasticizer be within the above range.

The swelling layer may contain one kind of plasticizer or two or more kinds of plasticizers.

The content of the plasticizer with respect to 100 parts by mass of the water-absorbent polymer is preferably 1 part by mass to 100 parts by mass, more preferably 5 parts by mass to 70 parts by mass, and even more preferably 10 parts by mass to 50 parts by mass.

The ratio of the total mass of the plasticizer to the total mass of the swelling layer is preferably 1% by mass to 35% by mass, and more preferably 3% by mass to 30% by mass.

From the viewpoint of improving durability, it is preferable that the swelling layer contain a pressure-sensitive adhesive component. The pressure-sensitive adhesive component can make the swelling layer function as a pressure-sensitive adhesive. In a case where the swelling layer functions as a pressure-sensitive adhesive, the water stopping tape is unlikely to be peel off from an object while being used, and the water stopping properties last for a long time.

Examples of the pressure-sensitive adhesive component include a pressure-sensitive adhesive component contained in the pressure-sensitive adhesive layer described above. The pressure-sensitive adhesive component contained in the swelling layer is preferably polyvinyl alcohol.

The swelling layer may contain one kind of pressure-sensitive adhesive component or two or more kinds of pressure-sensitive adhesive components.

The ratio of the total mass of the pressure-sensitive adhesive component to the total mass of the swelling layer is preferably 1% by mass to 20% by mass.

The width of the swelling layer is preferably smaller than the width of the substrate layer. That is, it is preferable that the swelling layer be provided on a part of the substrate layer without completely covering the substrate layer. It is preferable that the swelling layer be provided so that the swelling layer is located at the center in the width direction of the substrate layer.

In a case where the water stopping tape includes the pressure-sensitive adhesive layer between the swelling layer and the substrate layer, the width of the swelling layer is preferably smaller than the width of the pressure-sensitive adhesive layer. That is, it is preferable that the swelling layer be provided on a part of the pressure-sensitive adhesive layer without completely covering the pressure-sensitive adhesive layer. It is preferable that the swelling layer be provided so that the swelling layer is located at the center in the width direction of the pressure-sensitive adhesive layer.

The thickness of the swelling layer is preferably 0.3 mm to 10 mm, more preferably 1 mm to 5 mm, and even more preferably 2 mm to 4 mm. In the present disclosure, “thickness of the swelling layer” is represented by the arithmetic mean of the thicknesses of the swelling layer measured at five sites.

The manufacturing method of the swelling layer is not limited. The manufacturing method of the swelling layer may include forming a swelling layer by using a water-absorbent polymer and forming at least one kind of deformation assisting structure selected from the group consisting of a groove and a cut in the swelling layer. The manufacturing method of the swelling layer may include forming a swelling layer by applying a water-absorbent polymer to a fiber assembly and forming at least one kind of deformation assisting structure selected from the group consisting of a groove and a cut in the swelling layer. The groove may be formed by cutting. The groove may be formed by pressing. The cut may be formed by cutting a portion of the swelling layer.

The swelling layer having a groove may be manufactured by a stripe coating method or an intermittent coating method. According to such a coating method, for example, a groove is formed at a site where the coating amount is relatively small. The manufacturing method of the swelling layer may include forming a swelling layer having a groove by using a water-absorbent polymer to be applied by a stripe coating method or an intermittent coating method. The manufacturing method of the swelling layer may include forming a swelling layer having a groove by applying a water-absorbent polymer to a fiber assembly by a stripe coating method or an intermittent coating method.

In the manufacturing method of the swelling layer, as necessary, the water-absorbent polymer may be dried. In the manufacturing method of the swelling layer, as necessary, the water-absorbent polymer may be heated. The heating temperature is preferably 50° C. to 200° C., and more preferably 100° C. to 180° C.

In the manufacturing method of the swelling layer, a composition containing a water-absorbent polymer may be used. The composition containing a water-absorbent polymer may contain other components such as a plasticizer, a pressure-sensitive adhesive component, a solvent, an ultraviolet absorber, an antioxidant, a crosslinking agent, a surfactant, a filler, a colorant, a light stabilizer, a thickener, and a polymerization initiator.

### Structure

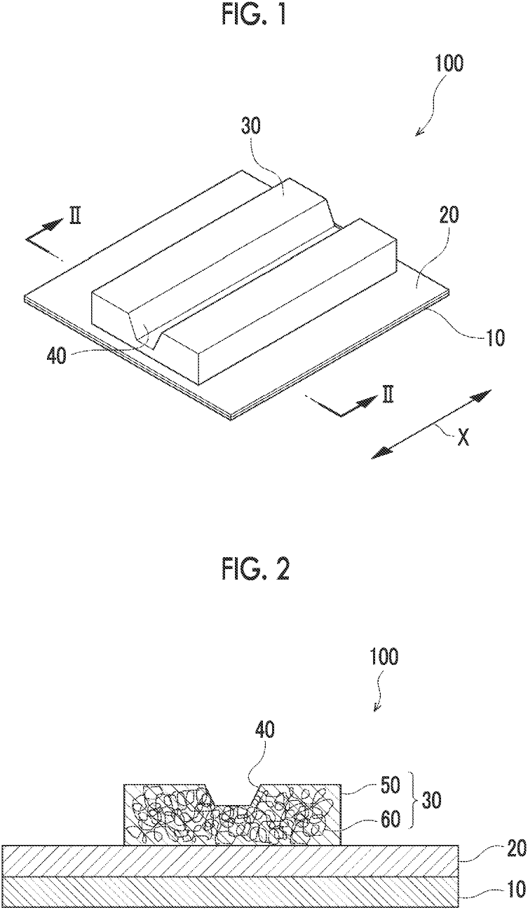

The structure of the water stopping tape will be described with reference to FIGS. 1 to 6. However, the structure of the water stopping tape is not limited to the structure shown in FIGS. 1 to 6.

First, FIGS. 1 and 2 will be described. FIG. 1 is a schematic perspective view showing a water stopping tape according to an embodiment. FIG. 2 is a schematic cross-sectional view showing a cross section taken along the line II-II in FIG. 1. A water stopping tape 100 shown in FIGS. 1 and 2 includes a substrate layer 10, a pressure-sensitive adhesive layer 20, and a swelling layer 30 having a groove 40.

The pressure-sensitive adhesive layer 20 is disposed on the substrate layer 10. Specifically, the pressure-sensitive adhesive layer 20 is disposed between the substrate layer 10 and the swelling layer 30.

The length of the pressure-sensitive adhesive layer 20 is approximately the same as the length of the substrate layer 10. The width of the pressure-sensitive adhesive layer 20 is approximately the same as the width of the substrate layer 10. The pressure-sensitive adhesive layer 20 covers one surface of the substrate layer 10.

The swelling layer 30 is disposed on the substrate layer 10 together with the pressure-sensitive adhesive layer 20. Specifically, the swelling layer 30 is disposed on the substrate layer 10 and the pressure-sensitive adhesive layer 20. That is, the swelling layer 30 is in contact with the substrate layer 10 via the pressure-sensitive adhesive layer 20. As a modification example, the swelling layer 30 may be in direct contact with the substrate layer 10. For example, in FIG. 2, the swelling layer 30 may be disposed in a state of being in direct contact with the substrate layer 10, and the pressure-sensitive adhesive layer 20 may be disposed on both sides of the swelling layer 30.

The width of the swelling layer 30 is smaller than the width of the substrate layer 10 and the width of the pressure-sensitive adhesive layer 20. A part of the surface of the pressure-sensitive adhesive layer 20 facing the swelling layer 30 is exposed. For example, by disposing the swelling layer 30 so that the swelling layer 30 faces a water permeating hole, and pressing the exposed surface of the pressure-sensitive adhesive layer 20 on a member in the vicinity of the water permeating hole, it is possible to fix the water stopping tape 100. As shown in FIG. 2, the position of the exposed surface of the pressure-sensitive adhesive layer 20 is lower than the position of the surface of the swelling layer 30 (specifically, a second surface of the swelling layer 30). As a modification example, the height of the exposed surface of the pressure-sensitive adhesive layer 20 may be changed so that the surface of the pressure-sensitive adhesive layer 20 and the surface of the swelling layer 30 are on the same plane.

As shown in FIG. 1, the groove 40 is in the form of a straight line extending along a first direction X. The first direction X corresponds to the longitudinal direction of the swelling layer 30. The first direction X also corresponds to the longitudinal direction of the water stopping tape 100. As shown in FIG. 2, the cross-sectional shape of the groove 40 is trapezoidal. The groove 40 opens in a direction away from the substrate layer 10. The groove 40 does not pass completely through the swelling layer 30. In a case where the groove 40 shown in FIGS. 1 and 2 is formed in the water stopping tape 100, for example, the water stopping tape 100 easily bends in the form of a projection protruding toward the swelling layer 30 from the substrate layer 10. That is, the water stopping tape 100 is easily deformed into a shape of mountain having the groove 40 of the swelling layer 30 as the apex. As a modification example, a plurality of grooves 40 may be formed.

The swelling layer 30 contains a water-absorbent polymer 50 and a fiber assembly 60. As shown in FIG. 2, the fiber assembly 60 is included in the water-absorbent polymer 50, and a mixed region where the water-absorbent polymer 50 and the fiber assembly 60 overlap each other is formed.

For example, during the construction using the water stopping tape 100 for preventing or reducing the flood damage on a building, the swelling layer 30 of the water stopping tape 100 is disposed to face gaps in an object such as a window or door. Because the groove 40 of the swelling layer 30 easily induces bending deformation of the water stopping tape 100, the water stopping tape 100 is deformed along the shape of the object, and a gap is unlikely to occur between the object and the water stopping tape 100 after construction. In a case where water reaches the water stopping tape 100 disposed on the object and comes into contact with the swelling layer 30, the swelling layer 30 having expanded by absorbing water closes gaps in the object, which can stop water from entering the building. Furthermore, the groove 40 facilitates the absorption of water into the swelling layer 30, which can reduce the time required for stopping water.

Next, FIG. 3 will be described. FIG. 3 is a schematic cross-sectional view showing a water stopping tape according to another embodiment. A water stopping tape 110 shown in FIG. 3 includes a substrate layer 11, a pressure-sensitive adhesive layer 21, and a swelling layer 31 having a groove 41.

The aspect of the water stopping tape 110 shown in FIG. 3 is substantially the same as the aspect of the water stopping tape 100 shown in FIGS. 1 and 2 except for the following points. That is, while the fiber assembly 60 is not in the groove 40 of the water stopping tape 100 shown in FIG. 2, a part of a fiber assembly 61 is in the groove 41 of the water stopping tape 110 shown in FIG. 3. In the water stopping tape 110, the groove 41 is defined by a water-soluble polymer 51 constituting the swelling layer 31, and a part of the fiber assembly 61 protruding from the water-soluble polymer 51 is in the groove 41. Even though a part of the fiber assembly 61 is in the groove 41, the groove 41 can form a starting point of bending deformation of the water stopping tape 110. Therefore, bending deformation easily occurs in the water stopping tape 110.

Next, FIG. 4 will be described. FIG. 4 is a schematic cross-sectional view showing a water stopping tape according to still another embodiment. The water stopping tape 120 shown in FIG. 4 includes a substrate layer 12, a pressure-sensitive adhesive layer 22, and a swelling layer 32 having a groove 42.

The aspect of the water stopping tape 120 shown in FIG. 4 is substantially the same as the aspect of the water stopping tape 100 shown in FIGS. 1 and 2 except for the following points. The first difference is that while the groove 40 of the water stopping tape 100 shown in FIG. 2 does not pass completely through the swelling layer 30, the groove 42 of the water stopping tape 120 shown in FIG. 4 passes completely through the swelling layer 32. The second difference is that while the groove 40 of the water stopping tape 100 shown in FIG. 2 is trapezoidal, the groove 42 of the water stopping tape 120 shown in FIG. 4 is rectangular. The third difference is that while the fiber assembly 60 is not in the groove 40 of the water stopping tape 100 shown in FIG. 2, a part of a fiber assembly 62 is in the groove 42 of the water stopping tape 120 shown in FIG. 4. In the water stopping tape 120, the groove 42 is defined by a water-soluble polymer 52 constituting the swelling layer 32, and a part of the fiber assembly 62 protruding from the water-soluble polymer 52 is in the groove 42. Even though a part of the fiber assembly 62 is in the groove 42, the groove 42 can form a starting point of bending deformation of the water stopping tape 120. Therefore, bending deformation easily occurs in the water stopping tape 120.

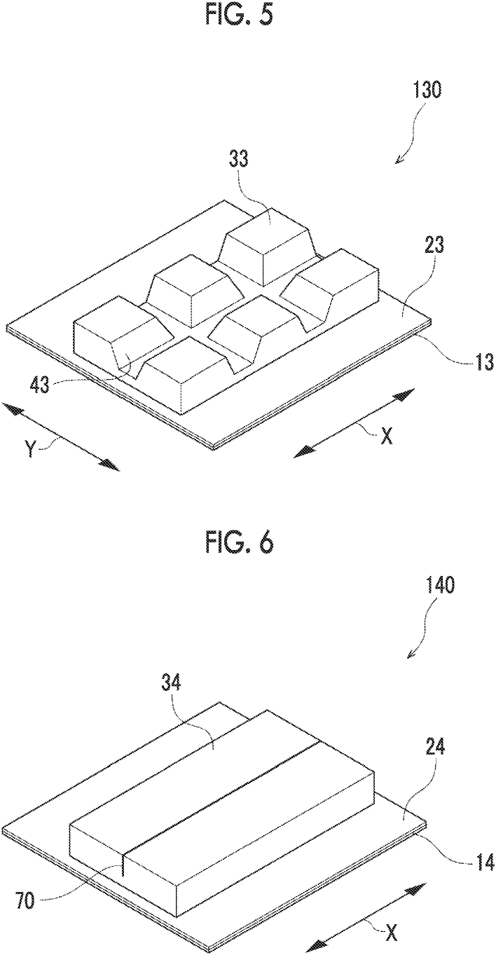

Next, FIG. 5 will be described. FIG. 5 is a schematic perspective view showing a water stopping tape according to yet another embodiment. The water stopping tape 130 shown in FIG. 5 includes a substrate layer 13, a pressure-sensitive adhesive layer 23, and a swelling layer 33 having a groove 43.

The aspect of the water stopping tape 130 shown in FIG. 5 is substantially the same as the aspect of the water stopping tape 100 shown in FIGS. 1 and 2 except for the following points. That is, while the groove 40 of the water stopping tape 100 shown in FIG. 1 is formed along the first direction X, the groove 43 of the water stopping tape 130 shown in FIG. 5 is formed along the first direction X and along a second direction Y that intersects with the first direction X at a right angle. Specifically, the groove 43 of the water stopping tape 130 is in the form of a lattice.

Next, FIG. 6 will be described. FIG. 6 is a schematic perspective view showing a water stopping tape according to another embodiment. A water stopping tape 140 shown in FIG. 6 includes a substrate layer 14, a pressure-sensitive adhesive layer 24, and a swelling layer 34 having a cut 70.

The aspect of the water stopping tape 140 shown in FIG. 6 is substantially the same as the aspect of the water stopping tape 100 shown in FIGS. 1 and 2 except for the following points. That is, while the water stopping tape 100 shown in FIG. 1 has the groove 40 formed along the first direction X, the water stopping tape 140 shown in FIG. 6 has the cut 70 formed along the first direction X. The cut 70 does not pass completely through the swelling layer 34. As a modification example, the cut 70 may be in the form of a lattice. As a modification example, a plurality of cuts 70 may be formed.

### Shape

The shape of the water stopping tape is not limited. The water stopping tape may be a flat plate-shaped water stopping tape. The water stopping tape may be a water stopping tape wound in a cylindrical shape.

### Use

The water stopping tape is used in various water stopping methods. The water stopping tape may be used for preventing or reducing water leakage. The water stopping tape may be used for preventing or reducing flooding. The water stopping method preferably includes preparing the water stopping tape and disposing the water stopping tape on an object so that the swelling layer of the water stopping tape and the object face each other. Disposing the water stopping tape on an object preferably includes attaching the water stopping tape to the object. The object may be a building. The object may be a window or a door. For example, in a case where water reaches the water stopping tape disposed on gaps in an object such as a window or a door, the swelling layer having expanded by absorbing water can close the gaps and stop water from entering.

### Water Stopping Tape According to the Second Embodiment

The water stopping tape according to the second embodiment includes a substrate layer, a pressure-sensitive adhesive layer, and a swelling layer. The pressure-sensitive adhesive layer is located on the substrate layer. The swelling layer is located on the substrate layer together with the pressure-sensitive adhesive layer. The water stopping tape has the following characteristics. That is, in a case where L1 represents a load necessary for causing a displacement of 1 mm in a 3-point bending test in which a load acting toward the swelling layer from the substrate layer is applied to a first measurement point, and L2 represents a load necessary for causing a displacement of 1 mm in a 3-point bending test in which a load acting toward the swelling layer from the substrate layer is applied to a second a measurement point, L1 and L2 satisfy a relationship of L1 < L2. According to the above embodiment, there is provided a water stopping tape having excellent workability. Presumably, because bending deformation easily occurs in the water stopping tape satisfying the relationship of L1 < L2, excellent workability may be obtained. Particularly, the water stopping tape satisfying the relationship of L1 < L2 is likely to bend in the form of projection protruding toward the swelling layer from the substrate layer. As a result, during the construction using the water stopping tape, for example, the water stopping tape is easily deformed along the shape of an object, and the workability is improved.

The preferable aspect of the load L1 and the load L2 measured using the water stopping tape according to the second embodiment is the same as the preferable aspect of the load L 1 and the load L2 measured using the water stopping tape according to the first embodiment described above in the section of “Water stopping tape according to the first embodiment”. The matters relating to the method and conditions of the 3-point bending test described above in the section of “Water stopping tape according to the first embodiment” are applied to the 3-point bending test for the water stopping tape according to the second embodiment. Both the “first measurement point” and “second measurement point” correspond to the contact point between the indenter and the water stopping tape used in the 3-point bending test.

The water stopping tape satisfying the relationship of L1 < L2 can be obtained, for example, by the following method. For example, a method of forming a relatively hard region and a relatively soft region in the water stopping tape makes it possible to form the water stopping tape satisfying the relationship of L1 < L2. The relatively hard region and the relatively soft region may be formed in the swelling layer. For example, properly selecting components of the swelling layer makes it possible to adjust the stiffness of the swelling layer and to form the relatively hard and the relatively soft region. For example, the stiffness of the swelling layer is adjusted by the molecular weight and crosslink density of polymers. The method of processing the water stopping tape to reduce the bending rigidity of the water stopping tape also makes it possible to form the water stopping tape satisfying the relationship of L1 < L2. For example, it is effective to use a method of processing the swelling layer to form a groove or cut. The groove or cut formed in the swelling layer can reduce the load necessary for causing a displacement of 1 mm in the 3-point bending test. Specific aspects of the swelling layer having a groove or cut are described above in the section of “Water stopping tape according to the first embodiment”.

The preferable aspect of the water stopping tape according to the second embodiment is the same as the preferable aspect of the water stopping tape according to the first embodiment described above in the section of “Water stopping tape according to the first embodiment”, except that the preferable aspect of the water stopping tape according to the second embodiment is based on the premise that the load L1 and the load L2 satisfy the relationship of L1 < L2.

### EXAMPLES

Hereinafter, the present disclosure will be specifically described with reference to examples. However, the present disclosure is not limited to the following examples. What are described in the following examples may be modified as appropriate as long as the modification is within the gist of the present disclosure.

### Example 1

A nonwoven fabric (trade name: TECHNOWIPE RN100-M, NIPPON PAPER CRECIA CO., LTD.) was cut in dimensions of 100 mm × 100 mm. By a stripe coating method, the nonwoven fabric was coated with a mixture of a polyurethane (2.0 g, trade name: AQUACALK TWB-P, SUMITOMO SEIKA CHEMICALS CO.,LTD.) and a plasticizer (0.4 g, trade name: ADEKACIZER RS-1000, ADEKA CORPORATION), and then subjected to a heating treatment at 150° C. for 1 minute using a hot press machine (MINI TEST PRESS MP-WCL, Toyo Seiki Seisaku-sho, Ltd.), thereby forming a swelling layer having a groove in the shape shown in FIGS. 1 and 2. Table 1 shows the dimensions of the groove. The central portion of the swelling layer was cut into a rectangle having dimensions of 50 mm × 100 mm. A pressure-sensitive adhesive tape (trade name: FIT LIGHT TAPE strong pressure-sensitive adhesive No. 736 Mango, width: 100 mm, SEKISUI CHEMICAL CO., LTD.) was cut in a length of 100 mm. The pressure-sensitive adhesive tape includes a substrate layer containing polyester and a pressure-sensitive adhesive layer. The swelling layer was attached to the central portion of the pressure-sensitive adhesive tape having dimensions of 100 mm × 100 mm. A water stopping tape was manufactured by the above procedure.

### Example 2

A water stopping tape was manufactured by the same method as in Example 1, except that the dimensions of the groove were changed according to the description in Table 1.

### Example 3

A water stopping tape was manufactured by the same method as in Example 1, except that the dimensions of the groove were changed according to the description in Table 1.

### Example 4

A water stopping tape was manufactured by the same method as in Example 1, except that a cut having the shape as shown in FIG. 6 was formed in the swelling layer instead of the groove.

### Example 5

A water stopping tape was prepared according to the method described in Example 1, except that a polyurethane film was manufactured by the heating treatment described in Example 1 without using a nonwoven fabric, and the polyurethane film was attached to a pressure-sensitive adhesive tape.

### Example 6

A water stopping tape was manufactured by the same method as in Example 1, except that the polyurethane used in Example 1 was changed to sodium polyacrylate (trade name: SUNFRESH ST-250, SANYO CHEMICAL INDUSTRIES, LTD.).

### Comparative Example 1

A water stopping tape was manufactured by the same method as in Example 1, except that no groove was formed in the swelling layer.

### Evaluation

By using the water stopping tapes manufactured in the examples and the comparative example, the following evaluation was performed.

### Workability

An acryl water tank was prepared which has a hole having a width of 30 mm and a height of 5 mm at the lower portion of the wall surface. The water tank has a width of 300 mm , a depth of 300 mm, and a height of 700 mm. The water stopping tape was attached to the inner bottom surface and the inner wall surface of the water tank, so that the swelling layer of the water stopping tape and the corner of the water tank (that is, the portion where the bottom surface and the wall surface cross each other) faced each other. In the process of attaching the water stopping tape to the water tank, for the water stopping tape including the swelling layer having a groove or cut, the groove or cut of the swelling layer was disposed along the corner of the water tank. The angle between the inner bottom surface and the inner wall surface of the water tank is 90°. A distance D between the corner of the water tank (that is, the portion where the bottom surface and the wall surface cross each other) and the water stopping tape was measured. Table 1 shows the evaluation results based on the following standard. The smaller the value of distance D, the better the workability.
A: D ≤ 1 mm
B: 1 mm < D ≤ 5 mm
C: 5 mm < D

### Durability

The water stopping tape was attached to the inner wall surface of the water tank described above in the section of “Workability” so that the swelling layer of the water stopping tape and a hole faced each other. Water was poured into the water tank to a height of 500 mm. The time taken for water to leak again out of the hole after being stopped from leaking out of the hole (that is, duration of water stoppage) was measured. Table 1 shows the evaluation results based on the following standard. The longer the duration of water stoppage, the better the durability.
A: The duration of water stoppage is 24 hours or more.
B: The duration of water stoppage is less than 24 hours.
C: Water keeps leaking out of the hole.

### Wetting Time

The water stopping tape was immersed in water, and a time T taken for the swelling layer of the water stopping tape to be totally wet was measured. Table 1 shows the measurement results based on the following standard.
A: T ≤ 1 minute
B: 1 minute < T <10 minutes
C: 10 minutes ≤ T

### Bending Deformability (L1/L2)

For the water stopping tape, a 3-point bending test was performed using a push-pull load cell. In the 3-point bending test, the distance between supporting points was set to 10 mm, and an indenter with a tip in the shape of a 45° cone was used. Specifically, in a 3-point bending test of applying a load acting toward the specific structure of the swelling layer (that is, at least one kind of deformation assisting structure selected from the group consisting of a groove and a cut) from the pressure-sensitive adhesive tape, a load L1 necessary for causing a displacement of 1 mm was measured. Then, in a 3-point bending test of applying a load acting toward a region of the swelling layer excluding the specific structure from the pressure-sensitive adhesive tape, a load L2 necessary for causing a displacement of 1 mm was measured. Table 1 shows the ratio of L1 to L2 (that is, L1/L2). The smaller the value of L1/L2, the easier it is for bending deformation to occur in the water stopping tape.

Table 1

| | Water-absorbent polymer | Nonwoven fabric (fiber assembly) | Deformation assisting structure | | | Workability | Durability | Wetting time | Bending deformability (L1/L2) |
|---|---|---|---|---|---|---|---|---|---|
| | | | Type | Depth (mm) | Width (mm) | | | | |
| Example 1 | AQUACALK TWB-P | TECHNOWIPE RN100-M | Groove | 0.5 | 2 | A | A | A | 30% |
| Example 2 | AQUACALK TWB-P | TECHNOWIPE RN100-M | Groove | 0.2 | 2 | B | A | A | 50% |
| Example 3 | AQUACALK TWB-P | TECHNOWIPE RN100-M | Groove | 0.2 | 1 | B | A | A | 60% |
| Example 4 | AQUACALK TWB-P | TECHNOWIPE RN100-M | Cut | 0.5 | 0 | A | A | B | 10% |
| Example 5 | AQUACALK TWB-P | | Groove | 0.5 | 2 | A | B | A | 30% |
| Example 6 | SUNFRESH ST-250 | TECHNOWIPE RN100-M | Groove | 0.5 | 2 | A | B | A | 30% |
| Comparative Example 1 | AQUACALK TWB-P | TECHNOWIPE RN100-M | | | | C | C | C | 100% |

Table 1 shows that the workability of Examples 1 to 6 is better than the workability of Comparative Example 1.

### Explanation of References

10, 11, 12, 13, 14: substrate layer

20, 21, 22, 23, 24: pressure-sensitive adhesive layer

30, 31, 32, 33, 34: swelling layer

40, 41, 42, 43: groove

50, 51, 52: water-absorbent polymer

60, 61, 62: fiber assembly

70: cut

100, 110, 120, 130, 140: water stopping tape

X: first direction

Y: second direction

What is claimed is:

1. A water stopping tape comprising:
a substrate layer;
a pressure-sensitive adhesive layer that is located on the substrate layer; and
a swelling layer that is located on the substrate layer together with the pressure-sensitive adhesive layer and has at least one kind of deformation assisting structure selected from the group consisting of a groove and a cut.

2. The water stopping tape according to claim 1,
wherein in a plane view of the water stopping tape observed from the swelling layer in a direction of the substrate layer, the deformation assisting structure is in the form of a line.

3. The water stopping tape according to claim 1,
wherein in a plane view of the water stopping tape observed from the swelling layer in a direction of the substrate layer, the deformation assisting structure is formed along a first direction orthogonal to a thickness direction of the swelling layer.

4. The water stopping tape according to claim 1,
wherein in a plane view of the water stopping tape observed from the swelling layer in a direction of the substrate layer, the deformation assisting structure is formed along a first direction orthogonal to a thickness direction of the swelling layer and along a second direction that intersects with the first direction.

5. The water stopping tape according to claim 1,
wherein the swelling layer contains a water-absorbent polymer and a nonwoven fabric.

6. The water stopping tape according to claim 1,
wherein the swelling layer includes a mixed region where a water-absorbent polymer and a nonwoven fabric overlap each other in a cross-sectional view.

7. A water stopping tape comprising:
a substrate layer;
a pressure-sensitive adhesive layer that is located on the substrate layer; and
a swelling layer that is located on the substrate layer together with the pressure-sensitive adhesive layer,
wherein in a case where L1 represents a load necessary for causing a displacement of 1 mm in a 3-point bending test in which a load acting toward the swelling layer from the substrate layer is applied to a first measurement point, and L2 represents a load necessary for causing a displacement of 1 mm in a 3-point bending test in which a load acting toward the swelling layer from the substrate layer is applied to a second measurement point, L1 and L2 satisfy a relationship of L1 < L2.
